(19) United States
(12) Patent Application Publication
(10) Pub. No.: US 2011/0126727 A1
(43) Pub. Date: Jun. 2, 2011

(54) Raised Image Plate Construction with Regions of Varying Support Thickness Beneath the Image Areas

(76) Inventor: Allan R. Prittie, Toronto (CA)

(21) Appl. No.: 12/919,240

(22) PCT Filed: Feb. 25, 2009
(86) PCT No.: PCT/CA2009/000213

§ 371 Date: Feb. 14, 2011

Related U.S. Application Data
(60) Provisional application No. 61/064,260, filed on Feb. 25, 2008.

(51) Int. Cl. B41F 7/02; B41C 3/00; B41F 3/34

(52) U.S. Cl. 101/217; 101/401.1; 101/492

(57) ABSTRACT

Optimum transfer of an optically discernible image from an ink supply to a substrate is effected. In one embodiment, a three dimensional image is created on the surface of an ink transfer medium layer. The height at a specific location of the three dimensional image corresponds to the ink volume to be transferred to that specific location in the printed image, allowing the color intensity to change throughout the printed image.

### FIELD OF INVENTION

This invention relates generally to the printing industry, and has to do particularly with an improved construction of a printing surface layer of relatively low stiffness and uniform thickness and a relatively higher stiffness varying thickness under-support layer. This construction is generally well applied in the raised image method of printing (sometimes referred to as the flexographic and/or as the letterpress process).

### BACKGROUND TO THE INVENTION

In accordance with the general terminology utilised in the printing industry, the word “letterpress” refers to a printing procedure in which the locations on the printing plate where ink is to be deposited are raised with respect to the areas where ink is not to be deposited. Within the general designation of letterpress printing, two distinguishable forms can be identified. The first typically uses a relatively stiff printing image transfer layer (i.e. employing a material of relatively high stiffness), and is commonly referred to in the industry as a “hard” plate. “Hard” plate letterpress systems typically employ an impression roll with a compliant coating and one or more form cylinder(s) also with compliant coating(s). The form cylinder(s) may be either directly inked from an ink fountain or well, or remotely inked through a series of rollers. The ink on the form cylinder(s) is transferred to the raised inking locations on the “hard” plade which is mounted to a plate cylinder. The web or sheet of substrate to be printed is entrained between the impression cylinder and the plate cylinder. With a “hard” plate, the impression cylinder must be relatively less stiff, in order to avoid damage to the raised portions of the printing plate due to mechanical interference, and/or to improve the evenness of ink transfer from the printing plate to the substrate to be printed.

In this specification, the quality of “stiffness” means the resistance of the material to deformation under a given force. For example, if equal thicknesses of two different materials were placed on a hard surface, and a given weight over a given area was impressed upon each of the materials, in order to deform or compress the materials, the material with the greater stiffness would yield less than the material with the lesser stiffness.

The second letterpress category utilises a printing plate commonly referred to in the industry as a “soft” plate. The stiffness of the printing surface layer is relatively lower than that of letterpress. That is to say, the raised areas which are to be inked and then which transfer the ink to the substrate are relatively less stiff with respect to the relatively more stiff ink supplying cylinder(s) and the relatively more stiff impression roll (frequently steel).

The term “flexographic” is often used to refer to the second letterpress system described immediately above, in which a relatively less stiff raised image carrying printing plate is used to receive an ink layer from the inking system and subsequently to transfer it to the sheet or web substrate upon which the image is to be placed.

In the raised plate printing method, the thickness of the printing construction as mounted to the plate cylinder is controlled to as uniform a thickness as is reasonably possible under the circumstances.

The printing industry generally recognises certain inherent problems relating to the raised plate printing method using a soft plate of uniform thickness. One of these problems relates to the degree to which the printing surface of the plate is urged against the substrate, depending upon the area of coverage of the ink. It is known that the degree to which a plate surface is urged against the substrate is preferably less for the less covered areas of the printing plate, and more for the more covered areas of that printing plate. The “urging” primarily comes about due to the squeezing or pinching of the soft plate material between the substrate and the plate cylinder. When the area less covered includes tiny dots due to the four-colour separation process, the dots are printed by an upstanding cone having on top a flat portion which accepts ink and then transfers or prints it as the dot. It is found generally that the amount of plate squeezing necessary to properly print solid-ink areas is too great to allow correct printing of the dotted areas, and creates excessive contact pressure of the dot onto the substrate. This excessive contact pressure in turn tends to expel ink from the space between the substrate and in the raised dot on the plate, thus forming a ring or “doughnut” of solid ink around a central zone of inadequate ink coverage. On the other hand, if the degree of separation between the plate and the impression roll is reduced to a level which allows a good printing of dots, it is found that areas of solid ink are inadequately printed, i.e. the ink is not fully and/or evenly transferred to the substrate.

It is known to provide, for use with the printing plate, a “make ready” plate which roughly corresponds image-wise to the plate in the sense that the “make ready” plate has an increased thickness in the regions corresponding to the more solid ink printing, and a gradually decreasing thickness in proportion to the degree of ink coverage in other regions of the plate. Areas of low ink coverage will include locations where a low density of colour is desired. The “counter makeready” is positioned under the plate with corresponding areas matched as well as possible mechanically, so that solid regions will tend to be urged more strongly against the substrate (i.e., squeezed more) than are the areas which are only partially ink covered. It is understood that this process has worked to some minor extent in the history of letterpress printing, but certainly not fully. It is not practically possible to align the print image on the printing plate with the image on the “counter makeready” plate. It involves considerable extra expense to fabricate the “counter makeready” plate, and it greatly complicates the process of affixing the plate to the printing plate mounting cylinder or platen.

Relative to the affixing of the plate to the plate cylinder, where a plate of relatively low stiffness is utilised without the “counter makeready” plate, it is typical in the industry to use a sheet of two-sided adhesive tape between the plate and the cylinder. Such tape may be very compliant (referred to in the printing industry as “cushion tape”), typically incorporating a layer of closed cell foam which is usually very low, and relatively uniform, in stiffness. It is also known to use relatively stiff or non-compliant tape. It has been found that, when a low-stiffness “cushion tape” is used to secure the plate to the plate cylinder, the plate-to-substrate contact pressure drops off too greatly in the locations of high ink coverage (area-wise), while the contact pressure between the plate and the substrate in the locations of relatively low ink coverage (area-wise) tends to allow more acceptable printing as the dots become smaller. The low-ink coverage areas are referred to as the “highlight areas” of the four-colour printing process. Conversely, when a stiff tape is used, the areas extrude ink outwardly to a larger diameter or total area than was originally intended, and the locations of heavy ink coverage (area-wise) usually print relatively properly. Therefore the use of “cushion tape” can only sometimes, and then only partially, be a useful compromise.

The methods and means disclosed in the applicant's U.S. Pat. No. 5,275,102 provide variable “urging” of the raised image printing surface firstly toward the inking system in order to receive ink and subsequently toward the substrate in order to deposit a high percentage of that received ink to the substrate. The variable urging capability incorporated into the construction helps the plate to receive and to transfer the ink generally in proportion to the percentage relative density of the raised image on the particular printing plate.

The nature of the prior art over which the present invention represents an improvement is exemplified by U.S. Pat. No. 5,275,102 with all of its References Cited, issued Jan. 4, 1994. The disclosure of this patent and all of its References Cited are incorporated herein by reference.

### DRAWBACKS OF THE PRIOR ART

One of the main drawbacks of these prior art printing plate constructions is that, after preparation and ultimate use to print one particular image, the complete construction is discarded to waste and usually ends up in a landfill site. In future, regulations for the disposal of these constructions, after use, will almost certainly require controlled collection and segregation in special landfill sites. This invention is directed towards the provision of a printing surface layer that is reusable for a multiplicity of required printing images for production orders.

A second main drawback of these prior art printing plate constructions is that they require considerable time, sometimes up to four hours, to perform the necessary processing steps to make the discrete raised image portion ready for use for a particular production order. Then, if one of these prior art printing plate constructions fails to print properly during the printing of an order, the press must wait until that printing plate construction can be remade. This invention is further directed towards the provision of a complete printing plate construction, ready for production, within a very short time, usually fewer than 10 minutes.

A third main drawback of these prior art printing plate constructions is that during their manufacturing and imaging processes very high volumes of nonreversible chemicals and photopolymer sludge are ultimately generated. Many of these chemicals are already required to be disposed of into specialised landfill sites. This invention also is directed towards dramatically reducing the volumes of chemicals required to make the printing plate constructions revealed in this disclosure.

### SUMMARY OF INVENTION

The present development relates to a way in which to address and solve the main drawbacks and shortcomings of all prior art raised image printing plate constructions known to the applicant.

In view of the foregoing discussion, and as set forth in paragraph [0011], one aspect of this invention facilitates optimum transfer of an optically discernible image from an ink supply to a substrate without having to provide an ink transfer medium layer which has, resident within itself, any discrete image dependent properties.

Preferably, a three-dimensional image is created behind the ink transfer medium layer such that the height of this image at a specific location in the image corresponds, substantially mathematically proportionally, to the desired discrete ink volume desired to be transferred to that specific location in the final printed image. Another embodiment of the present invention does not require the use of a separate ink transfer medium layer. In this embodiment ink, is proportionately directly received by the surface of the three-dimensional image and subsequently transferred as the ultimate printed image to a substrate.

In the preferred embodiment, the three-dimensional image provides a varying urging, in a multiplicity of both lateral and longitudinal positions, substantially through the ink transfer medium layer, thus creating varying transfer pressure which is proportional to the density of ink desired to be transferred, firstly on the ink supply and then on the substrate. In another embodiment, the three-dimensional image provides both the varying urging and the proportional receipt and proportional transfer of ink.

In a second aspect of this invention and with reference to paragraph [0013], the three-dimensional image in the preferred embodiment is created by the addition of material, rather than using prior art material subtraction methods. This method allows creation of a very accurately laterally and longitudinally positioned image in less than 10 minutes time. Should there be any need to re-create or modify the image during the running of a job, this can also be done in the same short period of time.

In a third aspect of the present invention, and with respect to paragraph numbers [0012] and [0014], it is an object to dramatically reduce the discarding of used printing plate constructions to landfill sites. In a particular embodiment of this invention, the image transfer layer is reused many times before recycling. Also, in this preferred embodiment, there is minimal waste created in the removal of the three-dimensional image after its use in production.

### METHOD

Additionally, the present invention provides a method of printing using a raised image printing process, the method comprising the steps:

providing a support surface,

depositing or accumulating relatively stiff material in predetermined locations of graduated regions of greater and lesser height between the support surface and an ink transfer medium layer,

the regions of greater height provided under image areas of greater desired ink coverage, and the regions of lesser height provided under image areas of lesser desired ink coverage,

providing an ink transfer medium which has an upper printing surface for printing an image,

depositing or accumulating relatively stiff material in predetermined locations of graduated regions of greater and lesser height between the support surface and the ink transfer medium layer portion,

the regions of greater height provided under image areas of greater desired ink coverage, and the regions of lesser height provided under image areas of lesser desired ink coverage,

securing the ink transfer medium layer portion to the support surface in such a way as to cover the graduated regions of greater and lesser height,

the surface of the ink transfer medium layer portion receiving ink from an ink supply, and

the surface of the ink transfer medium layer portion then depositing or printing a portion of that received ink as an image to a substrate using the upper printing surface of the ink transfer.

### APPARATUS

More particularly, this invention provides, for use in a raised image printing process employing a plate support, an improved plate construction, comprising:

a flexible ink transfer medium having an upper printing surface for printing an image on a substrate, the image including areas of greater ink coverage and areas of lesser ink coverage,

a low compressibility, low compression set, three-dimensional image which is created either directly on the plate support, or on a thin image carrying layer which is then mounted to the plate support,

the three-dimensional image providing regions in X and Y dimension of greater and lesser height (Z dimension),

the graduated regions of greater and lesser height being urged against the non-printing surface of the flexible ink transfer medium, in order to effect a controlled and varying degree to which the upper printing surface of the flexible ink transfer medium is urged against the substrate in order to transfer ink to the substrate,

greater pressure being transferred through the flexible ink transfer medium under image areas of greater desired ink coverage, and lesser pressure being transferred through flexible ink transfer medium under areas of lesser desired ink coverage, the flexible ink transfer medium having a substantially constant thickness when in a relaxed state.

### BRIEF DESCRIPTION OF DRAWINGS

FIG. 1 is a copy of two multicolored pressure-sensitive labels which have been printed side-by-side with the substrate traveling in the direction of the arrow in the diagram. These labels were printed as part of a production run in which 4 label images were printed side-by-side. After printing the label images and diecutting the label shapes, the 4 images were then slit apart and rewound for later automatic labelling onto a particular product container.

FIG. 2 is an enlarged view of a portion of one label image shown in rectangle 1 of FIG. 1;

FIG. 3 is a portion of FIG. 2, truncated at section A-A of FIG. 1, in order to describe particular regions of the printed image of FIG. 1;

FIG. 4 is a schematic isometric showing four substantially identical three-dimensional images located side-by-side on a printing support which, in this embodiment, is a cylinder.

FIG. 5 is an expanded view of one of the schematic isometric three-dimensional images of FIG. 4;

FIG. 6 is an end-elevational view of a printing cylinder support. In this embodiment an ink supply system, which is represented by a cylinder, is mounted above a print cylinder support in such a fashion as to supply a correct amount of ink as is required by a print transfer medium which is mounted to the plate cylinder support. In this embodiment an impression system which is represented by a cylinder, is mounted below the plate cylinder support in such a fashion as to present a substrate to the print transfer medium in order that the substrate may receive a portion of the ink layer which has been carried to it by the print transfer medium.

FIG. 7 is a side elevational view of FIG. 6;

FIG. 8 is an expanded view of the rectangle 208 in FIG. 7, showing an end view of section A-A in FIG. 6 and FIG. 7. Areas 206 and 207 represent a sectional view of a three-dimensional segment of a relatively low compressibility, relatively low compression set, pressure urging image.

FIG. 9 is also an expanded view of the rectangle 208 in FIG. 7. In this embodiment, between the plate cylinder support and the pressure urging image, there is added a flexible but dimensionally stable and highly stiff layer 202 which acts as a carrier for the pressure urging image;

FIG. 10 is also an expanded view of the rectangle 208 of FIG. 7. In this embodiment, an ink transfer medium 203 is shown as having been wrapped around said pressure urging image. Attention is respectfully drawn to another embodiment of this invention in which the ink transfer medium layer 203 is not employed. In that embodiment, ink is received directly to the surface of the three-dimensional layer and subsequently transferred from that surface to a substrate.

FIG. 11 is a view of FIG. 10, to which has been added representational volumes of ink deposited upon said ink transfer medium at locations 209 and 210; and

FIG. 12 depicts one representative arrangement of part of a device which is intended to create the pressure urging image.

### DESCRIPTION OF PREFERRED EMBODIMENT

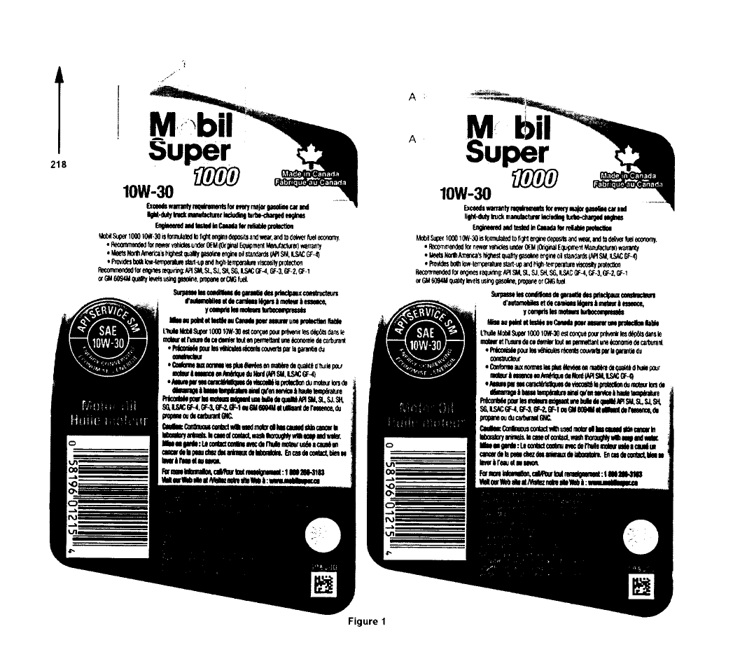

Reference is firstly made to the partial image shown in rectangle 1 of FIG. 1. This is a portion of a multicoloured label which is adhered to a carrier web (not illustrated in FIG. 1) and which will be later transferred to a container during the container filling production operation. The peripheral shape of the label in this form has been diecut from a continuous web substrate and the surrounding substrate waste matrix removed.

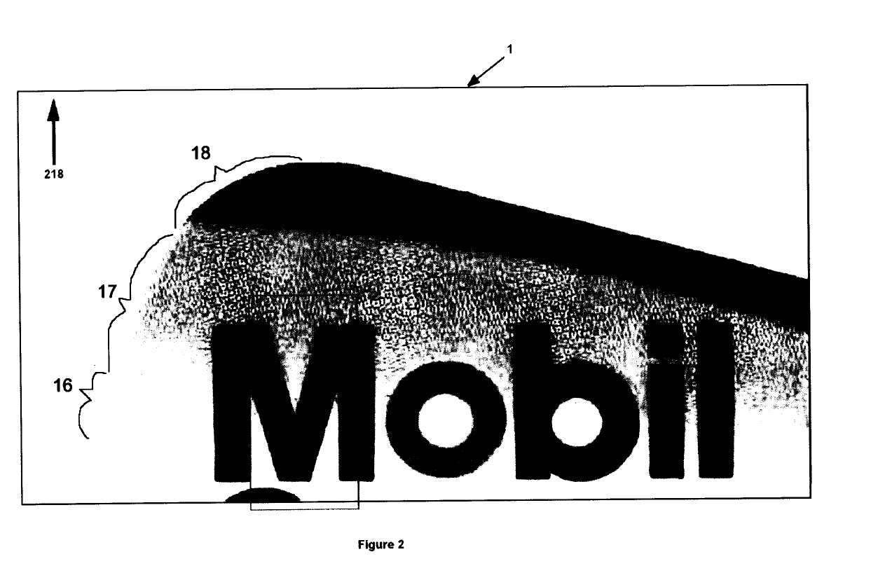

FIG. 2 is an expanded view of rectangle 1 showing the printed letters completely filled with ink. In the printing industry, these completely filled letters are commonly referred to as “solid” copy. In the original label, letters M,b,i, and 1 are all in solid blue ink colour and the letter o is in solid red colour.

Regions 16, 17, and 18 are also printed using the blue ink and are printed with the same printing plate as is printing the solid copy. However, regions 16, 17, and 18 are printed with lower colour intensity than are the solid letters. The area combining regions 16, 17, and 18, is commonly referred to as a “vignette”. Also, region 18 is referred to as a “shadow”, region 17 is referred to as a “mid-tone” and region 16 is referred to as an “highlight”. A vignette can, for example, represent a continuous change from zero colour intensity all the way up to solid colour intensity. In this particular example of the vignette in rectangle 1, there is a graduation from zero colour intensity gradually increasing in intensity through regions 16, and 17. It will be seen that the shadow region 18 represents a high rate of change of intensity of ink. Increasingly during this high rate of change, a commensurate higher amount of ink is being transferred to the shadow region 18.

With reference to the prior art cited, raised image plate constructions normally use a varying multiplicity of truncated cones of varying diameter in order to receive ink from an inking system and to then substantially transfer that ink as a vignette to a substrate. These truncated cone regions are created in the printing plate construction by removing or subtracting unexposed photopolymer after the construction has been subjected to exposure to light transmission through an imaged film layer which is a modified negative of the image to be printed. The removed photopolymer residue must be collected and discarded.

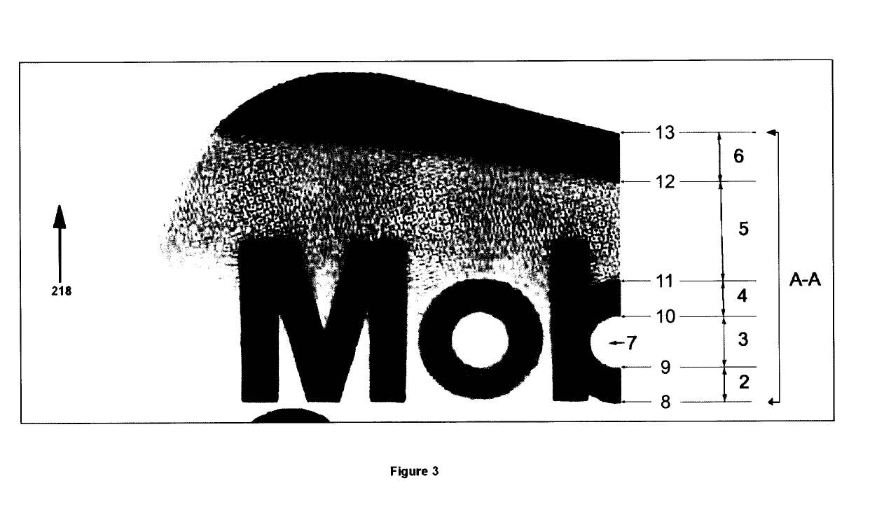

In FIG. 3, FIG. 2 is repeated, but has been cut off in a vertical line through the letter b for clarity of description. The section A-A represents an edge-elevational view.

Region 2 which starts at position 8 and ends at position 9 is a region of solid colour.

Region 3 which starts at position 8 is a region which starts at zero colour intensity until approximately position 7. It then begins to gain colouration and extends as a highlight until it reaches position 10.

Region 4 which starts at position 10 and ends at position 11 is also a region of solid colour.

Region 5 which starts at position 11 is a region in which colour intensity is further increased as a “mid-tone” extending the colour intensity (which was begun as an “ highlight” at location 7 and continued up to location 10) further to location 12.

Region 6 which starts at position 12 and extends to the edge of the diecut periphery at location 13, exhibits further increasing colour intensity as a “shadow”.

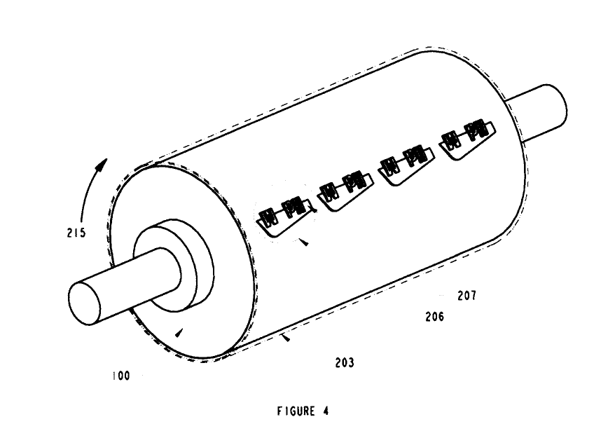

In FIG. 4, a portion of a three-dimensional varying height pressure creating layer 207 whose image is representative of the partial label image in rectangle 1 is shown within ellipse 206 as being wrapped on a plate cylinder support 100. The portion of height pressure creating layer 207 within ellipse 206 is shown duplicated across the face of the plate cylinder support 100 to represent 4 label images being printed side-by-side as the plate cylinder support 100 rotates in the direction of arrow 215. This FIG. 4 also depicts an ink transfer medium 203 which is wrapped over varying height pressure creating layer 207 within ellipse 206. As has been previously described, this ink transfer medium 203 can be eliminated in another embodiment of the present invention, while still employing its novelty.

It is an aspect of this invention that the ink transfer medium 203 be reusable after having been employed in a print production run. The varying height pressure creating layer 207 is used to create a directly localised variable urging of the ink transfer medium 203 firstly toward an ink supply in order to receive ink to the urged surface of ink transfer medium 203 and then, sequentially, toward a substrate in order to transfer the ink image from the surface of the ink transfer medium 203 to that substrate.

After the production run has been completed, the ink transfer medium 203 can be unwrapped from the varying height pressure creating layer 207. It then rapidly recovers its original compression set and can be reused.

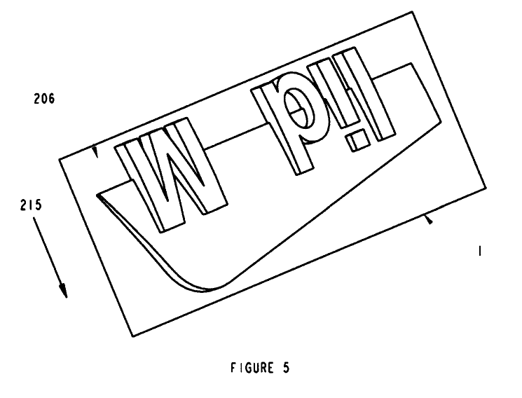

FIG. 5 depicts an expanded view of the varying height pressure creating layer 207 which is enclosed in ellipse 206 of FIG. 4. The blue ink portion within rectangle 1 of FIG. 1 also corresponds to this FIG. 5 (but not the solid red ink letter o in rectangle 1).

It will be considered that the letters of the varying height pressure creating layer 207 are depicted at the maximum deposited or accumulated height of this layer 207 in order to ultimately print as solid copy. It will also be considered that the varying height portion of this layer 207 is depicted as having been deposited or accumulated to a lesser elevation than maximum in order to create the vignette (with reference to FIG. 3) which begins at zero colour intensity at location 7 and extends to location 10 as a highlight and then extends from location 11 to location 13 through a mid-tone and to a shadow in the vignette.

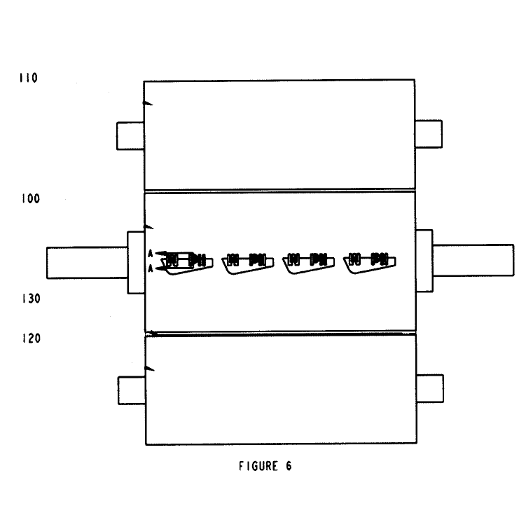

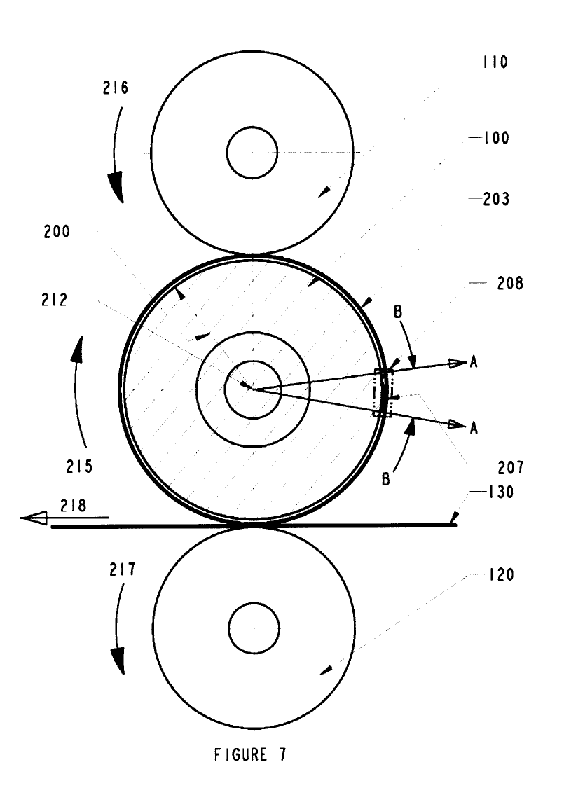

FIG. 6 and FIG. 7 are intended to depict a portion of one embodiment of a printing system in which the present invention can be employed. In this preferred embodiment only, a varying height pressure creating layer 207 is shown directly deposited or accumulated onto a plate cylinder print support 100. In FIG. 7 ink transfer medium layer 208 is showing as over-wrapping varying height pressure creating layer 207. In another embodiment of the present invention it will be understood by those knowledgeable in the art that ink transfer medium 203 can be eliminated from the construction.

The ink supply system, shown in this embodiment as being presented into close contact with the present invention, is here shown as one rotating cylinder, ink supply 110. In this particular embodiment, the varying height pressure creating layer 207 will be seen as having been urged into mechanical contact with ink supply 100, in order to receive ink.

The means to urge substrate 130 against ink transfer medium layer portion 203 is represented, in this embodiment of the present invention as a cylinder, impression cylinder 120.

As the substrate 130 is moved in the direction of arrow 218 in FIG. 7 (by motive means not shown) cylinders 110, 100, and 120 are rotated in the directions of their respective arrows 215, 216, and 217 and with substantially identical surface speed to that of the substrate 130 (by synchronous motive means not shown). This action allows the ink transfer medium 203 to be firstly urged by the varying height pressure creating layer 207 against the inking system 110 in order to receive ink, and subsequently against the substrate 130, in order to substantially transfer the just received ink to the substrate 130.

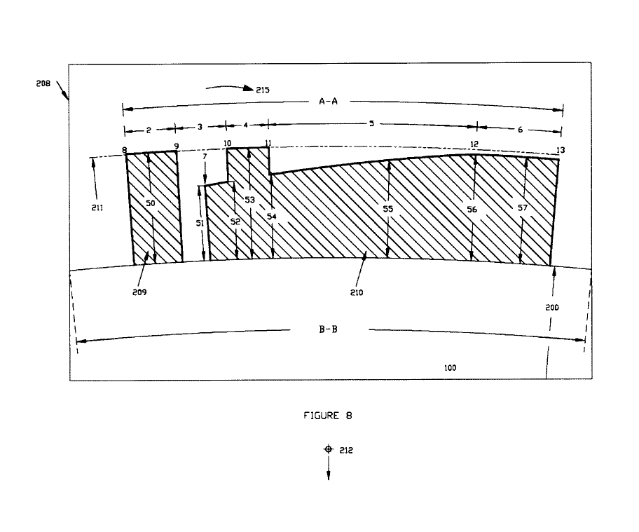

Rectangle 208 in FIG. 7 is again shown in end-elevational view in FIG. 8, having been expanded. A portion of chordal segment B-B which in FIG. 7 has center 212, is truncated in this FIG. 8 with center to 12 indicated to be remotely located for convenience of this description. Varying height pressure creating layer 207 is represented in this FIG. 8 by areas 209 and 210. It is considered that the height 50 of the area 209 and the height 53 of area 210 are the maximum heights required of layer portion 207 in order to ultimately produce solid ink coverage between locations 8 and 9, and locations 10 and 11 respectively (and with reference to the image regions 2 and 4 of FIG. 3). It is also considered that the graduated heights 51-52 from location 7 to location 10 and the graduated heights 54-57 extending from location 11 to location 13 are the correct proportional heights of layer portion 207 in order to induce the proper ink transfer to print the required vignette in region 3 and regions 5 and 6. It will be understood that location 13 is also the location at which the diecut edge of the label used to describe this embodiment of the present invention appears.

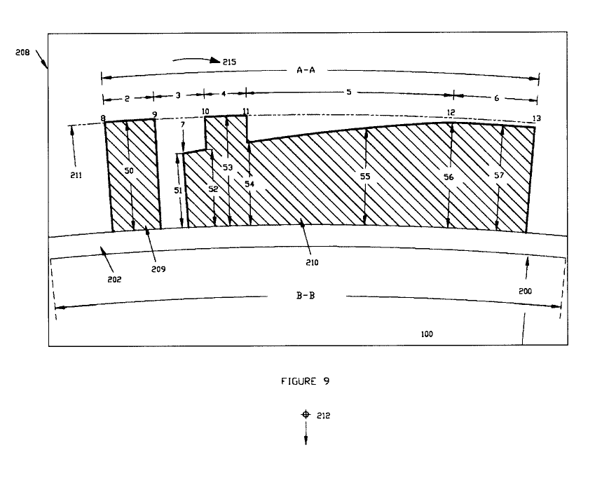

FIG. 9 is a repeat of FIG. 8 which also includes a high stiffness, substantially dimensionally stable flexible image carrier layer 202. Although this layer 202 is not required to describe the essence of this invention, it can be used in an embodiment when it is desired to deposit or accumulate the variable pressure creating layer portion 207 firstly to an independent, stable image carrier sheet or tube rather than directly to a print support such as plate cylinder print support 100.

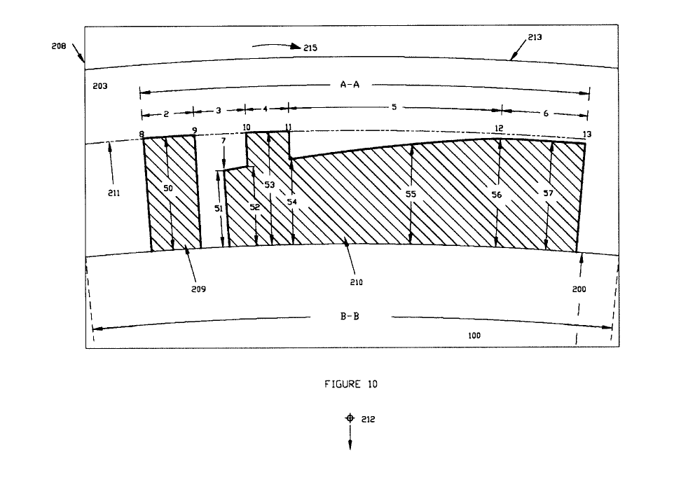

FIG. 10 is also a repeat of FIG. 8 which now represents and includes the overlaying or overwrapping of ink transfer medium 203 onto, and close contact with, varying height pressure creating layer 207. Although not shown in this depiction, ink transfer medium 203 (under hoop stress) conforms closely to the localised heights of the varying height pressure creating layer 207. This conformance allows varying amounts of ink to be received by printing surface 213 of ink transfer medium layer 203 from an ink system such as is represented by ink supply 110, and then transferred to substrate 130 by rotation of plate cylinder print support 100.

The amount of ink transferred to the substrate, at a certain position in the image, will be seen to be substantially directly proportional to the urging created by the varying height pressure creating layer 207 at that certain position in the image. This urging is transmitted directly through ink transfer medium 203 to the substrate 130 as it moves in the direction of arrow 218.

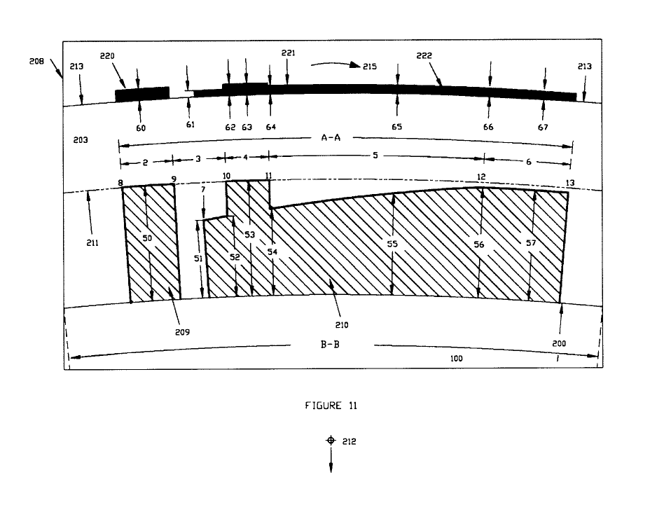

FIG. 11 is a repeat of FIG. 10 which now shows ink deposits 220 and 221. These will be seen to be lying on the outer printing surface 213 of ink transfer medium 203. In this state of rotation in the direction of arrow 215 of plate cylinder print support 100 (in FIG. 7), these ink deposits 220 and 221 have just been received from ink supply 110. It will also be seen, within this particular embodiment of this invention, that the ink received by printing surface 213 has intentionally been received non-uniformly.

The urging action of the varying height pressure creating layer 207, by transmission through ink transfer medium 203 urges the printing surface 213 against ink supply 110 in this particular embodiment. The result is that ink is received by printing surface 213 approximately in proportion to the varying urging action of varying height pressure creating layer 207.

It will be seen that this intended non-uniformity in the received ink volumes and locations upon printing surface 213 is not due to any properties resident in ink transfer medium 203.

Hence, ink transfer medium 203 can be unwrapped and reused when a particular production run has been completed.

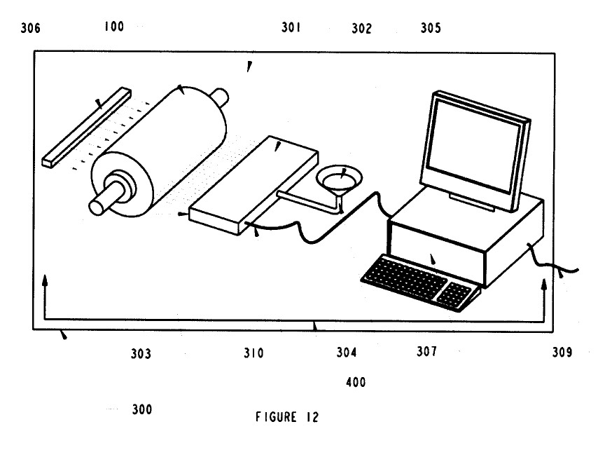

FIG. 12 shows the preferred embodiment of a partial section of a representational equipment construction, device 400 which is generally located within rectangle 300, and which is used to create the varying height pressure urging layer 207 on a print support such as plate cylinder print support 100.

Plate cylinder print support 100 is firstly securely mounted into device 400 and is positionally axially and longitudinally restrained (by means not shown) to allow rotation (by means not shown) about axis 301.

A material discharge system 302 is provided and is mounted (by means not shown) with its discharge face 303 in close proximity to the outside diameter of plate cylinder print support 100.

Discrete discharge elements (not here shown) are located across the discharge face 303, at the lineal density of up to 1000 locations per inch, for example.

These discrete discharge elements can each discharge a discrete transfer volume, for example only, in the quantums 0-100 picolitres per discharge command.

Funnel 304 is representative of a container which holds discharge material 305, the container being connected to discharge system 302. By this means, discharge material 305 can be continuously supplied, as is necessary, to the discrete material dispensing systems (not here shown and located within discharge system 302).

An energy supply system 306 is provided to effect stiffening of discharge material 305 after it has been transferred from discharge system 302 to the surface of plate cylinder print support 100.

A digital control system 307, which in this embodiment is here representationally shown within rectangle 308, is fed print order related data including print image data via a high speed modem link 309. The digital control system 307 connected via datalink 310 directs the actuation of each of the discrete discharge elements which are mentioned in subsections 57.3 and 57.4.

Software and hardware coordinating and directing means (here not shown) control and synchronise the rotation of plate cylinder print support 100 in cooperative conjunction with the commands to transfer discrete volumes of discharge material 305 from discharge face 303 to discrete locations on the surface of plate cylinder print support 100.

A data file containing information on a particular image which is desired to be printed in an upcoming production run is loaded into control system 307 through modem link 309. This information can have been pre-organised and/or is then processed by control system 307 to later direct the positioning and deposit volume required of each of the discrete discharge elements in order to create the varying height pressure creating layer 207 upon plate cylinder print support 100.

In the production operation of device 300, the plate cylinder print support 100 is rotated during the creation of the varying height pressure creating layer 207. A multiplicity of layers of discharge material 305 is sequentially deposited and then stiffened through exposure of the layers by energy supply system 306.

In order to create a graduated deposit on the surface of plate cylinder print support 100 so as to ultimately print a desired vignette, the data controlling the emission of discharge material 305 from the discrete discharge elements located across discharge face 303 can be arranged to direct a controlled varying output of discharge material 305 in each rotation of plate cylinder print support 100.

With this control over the polar and lateral positions of each deposit and the combined ability to effect a deposit in each position (or not), gradually rising deposits of discharge material 305-rising proportionally and corresponding directly to the desired colour intensity of the vignette to be ultimately transferred print surface 213 to substrate 130 can be directed.

### SUMMARY OF DISCLOSURE

In summary of this disclosure, the present invention relates to a novel raised image plate construction in which the ink image transfer medium is reusable. Without having its resident properties altered, an ink image transfer medium, which is of relatively low stiffness and substantially uniform thickness, can be temporarily imbued with the ability to receive ink substantially in the form of a predetermined image, and then to transfer that inked image to a substrate, the image including areas of greater ink coverage and areas of lesser ink coverage. A three-dimensional substantially non-compressible image representing layer is used to create image distinct urging pressure through the image transfer medium in order to vary the amount of ink received and transferred by said image transfer medium to the substrate.

While three embodiments of the present invention have been illustrated in the accompanying drawings and described herein above, it will be evident to those skilled in the art that changes and modifications may be made therein, without departing from the essence of this invention.

What is claimed is:

1. A method for use in an image transfer system, comprising:
(a) providing an image support,
(b) providing a first delivery supply for a first material with which to create a desired image onto a substrate,
(c) providing a second delivery supply for a second material, this second delivery system to deposit this second material to the image support surface at predetermined locations to provide graduated regions to greater and lesser height, this second material adhering to the image support surface,
(d) providing a transfer medium to firstly accept a deposit of the first material and then secondly to substantially transfer this deposit to a substrate,
(e) mounting a first surface of the transfer medium to the predetermined locations of the deposited second material,
(f) delivering portions of the first material to the second surface of the transfer medium, and
(g) transferring substantially the delivered portions of the first material from the second surface of the transfer medium to the substrate.

2. The method of claim 1, wherein, while eliminating the use of the transfer medium, firstly delivering the portions of the first material directly to the outer surfaces of the deposited second material and then secondly transferring substantially the delivered portions of the first material to the substrate.

3. The method of claim 1 or claim 2, wherein an image carrier layer is provided between the image support surface in such a way as to receive the deposit of the second material.

4. The method of any one of claims 1 to 3, wherein the first material is a printing ink.

5. A method of printing using a raised image printing process, the method comprising the steps:
(a) providing a support surface,
(b) depositing or accumulating relatively stiff material in predetermined locations of graduated regions of greater and lesser height between the support surface and an ink transfer medium layer, the regions of greater height provided under image areas of greater desired ink coverage, and the regions of lesser height provided under image areas of lesser desired ink coverage,
(c) providing an ink transfer medium which has an upper printing surface for printing an image,
(d) depositing or accumulating relatively stiff material in predetermined locations of graduated regions of greater and lesser height between the support surface and the ink transfer medium layer portion, the regions of greater height provided under image areas of greater desired ink coverage, and the regions of lesser height provided under image areas of lesser desired ink coverage,
(e) securing the ink transfer medium layer portion to the support surface in such a way as to cover the graduated regions of greater and lesser height,
(f) receiving ink from an ink supply on the surface of the ink transfer medium layer portion, and
(g) the surface of the ink transfer medium layer portion or a portion of that received ink as an image to a substrate using the upper printing surface of the ink transfer medium layer portion.

6. For use in an image transfer system, an apparatus employing an image support an improved image transfer construction comprising:
(a) a mounting frame,
(b) means to constrain the flow of an elongate web through the mounting frame,
(c) a first cylinder which can be constrained to be parallel, in two planes, with the elongate web as it flows through the mounting frame,
(d) a second cylinder which can also be constrained to be parallel, in two planes, with the elongate web as it flows through the mounting frame,
(e) means to deposit a graduated three-dimensional image across and around the first cylinder,
(f) means to mount a transfer medium layer over, and in close contact with, the three-dimensional image which has been deposited onto the first cylinder, the transfer medium having its second surface adapted to firstly receive and secondly to substantially transfer a first material in the form of an image, the image including areas of greater first material coverage and areas of lesser first material coverage,
(g) means to supply a first material, with which to create a desired image onto a substrate, to the surface of the variably raised portions of the transfer medium layer,
(h) means to synchronously drive the first and second cylinders, such that their surface speeds are at a controlled ratio, and
(i) means to adjust the gap between the first cylinder and the second cylinder such that the first material, which has just been received by the flexible transfer medium layer, can be transferred to the elongate web to create the desired image on that web.

7. The apparatus of claim 6, wherein, while eliminating the use of the transfer medium, thereby delivering the portions of the first material directly to the outer surfaces of the deposited second material and then secondly transferring substantially those delivered portions of the first material directly to the elongate web.

8. The apparatus of claim 6 or claim 7 wherein an image carrier layer is mounted to the first cylinder and to which the three-dimensional image of first material is deposited and adhered.

9. The apparatus of any one of claims 6 to 8 in which the first material is a printing ink.

10. An improved plate construction for use in a raised image printing process employing a plate support, comprising:
(a) a flexible ink transfer medium having an upper printing surface for printing an image on a substrate, the image including areas of greater ink coverage and areas of lesser ink coverage,
(b) a low compressibility, low compression set, three-dimensional image which is created either directly on the plate support, or on a thin image carrying layer which is then mounted to the plate support, the three-dimensional image providing regions in X and Y dimension of greater and lesser height (Z dimension), the graduated regions of greater and lesser height being urged against the non-printing surface of the flexible ink transfer medium, in order to effect a controlled and varying degree to which the upper printing surface of the flexible ink transfer medium is urged against the substrate in order to transfer ink to the substrate, and
(c) greater pressure being transferred through the flexible ink transfer medium under image areas of greater desired ink coverage, and lesser pressure being transferred through flexible ink transfer medium under areas of lesser desired ink coverage, the flexible ink transfer medium having a substantially constant thickness when in a relaxed state.
